(19) United States
(12) Patent Application Publication
(10) Pub. No.: US 2006/0180433 A1
(43) Pub. Date: Aug. 17, 2006

(54) Bucket wheel-operated device for handing over printed products

(76) Inventors: Udo Ferino, Grunstadt (DE); Holger Ratz, Frankenthal (DE)

Correspondence Address: Douglas R Hanscom;Jones Tullar & Cooper, P O Box 2266 Eads Station, Arlington, VA, 22202, US

(21) Appl. No.: 10/543,506

(22) PCT Filed: Nov. 7, 2003
(86) PCT No.: PCT/DE03/03697

§ 371 Date: Jul. 27, 2005

(30) Foreign Application Priority Data
Feb. 5, 2003 (DE) 10304564.3

(51) Int. Cl. B65G 47/84

(52) U.S. Cl. 198/440

(57) ABSTRACT

Please add the Abstract of the Disclosure as set forth on the separate accompanying sheet. That Abstract of the Disclosure is essentially the same, in content, as the Abstract which is a part of the published PCT application WO 2004/069704A2. No new matter is being presented by the addition of this Abstract of the Disclosure.

### CROSS-REFERENCE TO RELATED APPLICATIONS

This patent application is the U.S. national phase, under 35 USC 371, of PCT/DE 2003/003697, filed Nov. 7, 2003; published as WO 2004/069704 A2 and A3 on Aug. 19, 2004 and claiming priority to DE 103 04 564.3, filed Feb. 5, 2003, the disclosures of which are expressly incorporated herein by reference.

### FIELD OF THE INVENTION

The present invention is directed to a device for the transfer of printed products, having a paddle wheel arrangement. The paddle wheel arrangement has a plurality of paddle wheels which are rotatable about an axis.

### BACKGROUND OF THE INVENTION

Transfer devices with paddle wheels are employed, for example, at the outlet of a folding apparatus for use in receiving folded printed products introduced by the folding apparatus into the paddles of the paddle wheel. The paddle wheels are thereafter used for transferring the folded products, in an overlapping manner, to a conveyor belt or to a conveyor chain that is equipped with grippers for the printed products. The subject invention relates to a transfer device of the latter type. Such a transfer device is generally known from Swiss Letters Patent 427 625.

With this type of transfer device; i.e. one that uses a conveyor chain with grippers, a problem occurs because the conveyor chain, which is looped around a deflection wheel which is rotating, along with the paddle wheel, on a common shaft, must be released from the deflection wheel in a tangential direction, so that a gripper, which is attached to the conveyor chain, takes along a gripped printed product in this tangential direction. However, the paddle, into which the printed product was inserted, continues its rotation around the shaft, so that the danger arises that the printed product buckles between the gripper and the paddle and is thereby damaged when the paths of the paddle and the gripper diverge.

In an effort to solve this problem, it has been proposed, in EP 0 931 011 B1, for the deflection wheel to be rotatorily driven at a lower angular velocity than the paddle wheel. The precessing of the paddle wheel produced by the utilization of this proposed solution achieves that, at the time when the gripper, which is holding a printed product, leaves the circumference of the deflection wheel, the paddle, which previously had contained the printed product, is already so far ahead in its continuing rotation, that further straight-ahead movement of the printed products is no longer hampered. Although it is possible, in this way, to prevent damage to the printed product, a careful matching of the speeds and the phases of the movements of the paddle wheel and the conveyor chain is required. If the precession or the speed of the paddle wheel is too slow, buckling of the printed product is not reliably prevented. If the precession or the speed is too fast, at the time the gripper closes around a printed product the paddle wheel, this can have such a lead, in respect to the gripper, that the printed product is no longer assuredly held and can be tilted or can even fall out of the paddle before the gripper closes.

### SUMMARY OF THE INVENTION

The object of the present invention is directed providing a device for transferring printed products, which includes a paddle wheel arrangement.

In accordance with the present invention, this object is attained by the provision of a device for transporting on transferring printed products that has a paddle wheel arrangement which has a plurality of paddle wheels that are rotatable around at least one axis. A conveyor chain supports a plurality of grippers. The conveyor chain passes around a deflection wheel which is situated between the two spaced paddle wheels and which is rotatable about an axis. Axes of rotation of the paddle wheels are inclined with respect to the axis of rotation of the deflection roller. The paddle wheel axes of rotation may also be inclined with respect to each other.

The advantages to be gained by the present invention consist, in particular, in that because of the inclination of the axes of the paddle wheels, at a location where the conveyor chain is released from the deflection wheel, the distance between the paddles of spaced paddle wheel disks, adjacent to the deflection wheel, can be greater than the width of the product to be transferred. Therefore, the product to be transferred can move off the paddle wheel disks, with the aid of the conveyor chain without the risk of damage by the paddles. This can be accomplished without an elaborate matching of phase position and of speeds of the paddle wheels and the deflection wheel being required, as was the case with prior devices.

To make the difference between the maximum and minimum spacing distances between the two paddle wheel disks adjacent to the deflection wheel variable, these two paddle wheels are preferably mounted to be pivotable transversely to their axes, on a frame.

The axes of the paddle wheel disks are preferably arranged in such a way that they intersect the axis of the deflection wheel, preferably at an angle of between 10° and 30°.

As a result of the inclination of the axes of rotation of the paddle wheels, the projection of the paddle wheels onto the plane of the deflection wheel is not circular, but instead is elliptical. It is not possible to achieve an absolute synchronization of the movements of the paddles with the rotation of the deflection wheel over the entire circumference. However, in the preferred range of the angle of inclination, the deviations do not cause any interference. This is particularly the situation in the case in which the centers of the projected ellipses coincide with the axis of the deflection wheel. To achieve as good a synchronization as possible of the movements of the grippers and of the paddles, in relation to the conveying direction of the handled products, the intersection of the shaft of a paddle wheel and the shaft of the deflection wheel should preferably be located at the level of the respective paddle wheel.

To adopt the device, in accordance with the present invention, to the handling of printed products of different widths, the paddle wheel disks should be displaceable along an axis of displacement, which preferably is the shaft of the deflection wheel.

Different rotational speeds of the paddle wheel disks on the one hand, and of the deflection wheel, on the other hand, are no longer required in the device. Therefore, drive assembles capable of accomplishing identical angular speeds are preferably provided for driving these elements.

Preferably, the deflection wheel and the paddle wheels, which are arranged on different sides of the paddle wheel, are assigned their own drive motors, which individual drive motors can be electronically coupled in order to assure an identical angular speed of the paddle wheels and of the deflection wheel. Mechanical coupling of the paddle wheels and the deflection wheel can also be considered.

### BRIEF DESCRIPTION OF THE DRAWINGS

Preferred embodiments of the present invention are represented in the drawings and will be described in what follows.

Shown are in:

FIG. 1, a side elevation view of the deflecting wheel with the conveyor chain looped around it, and of a paddle wheel of the transfer device in accordance with the present invention, in

FIG. 2, a perspective plan view of the deflection wheel, the conveyor chain, as well as of two paddle wheels situated adjacent to the deflection wheel, in

FIG. 3, a front view of a slightly modified embodiment of the transfer device, and in

FIG. 4, a variation of the transfer device in accordance with the present invention.

### DESCRIPTION OF THE PREFERRED EMBODIMENTS

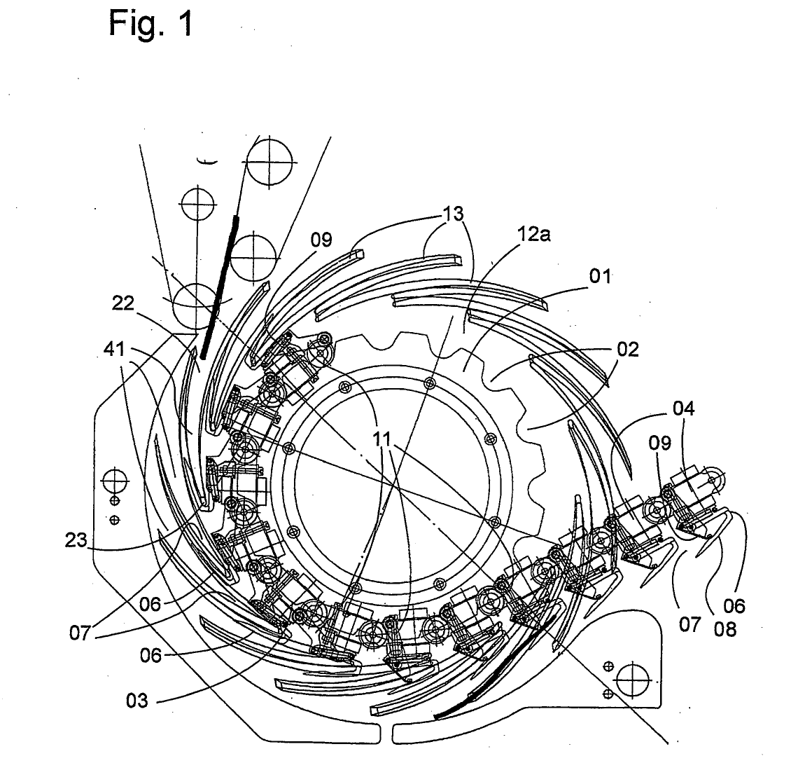

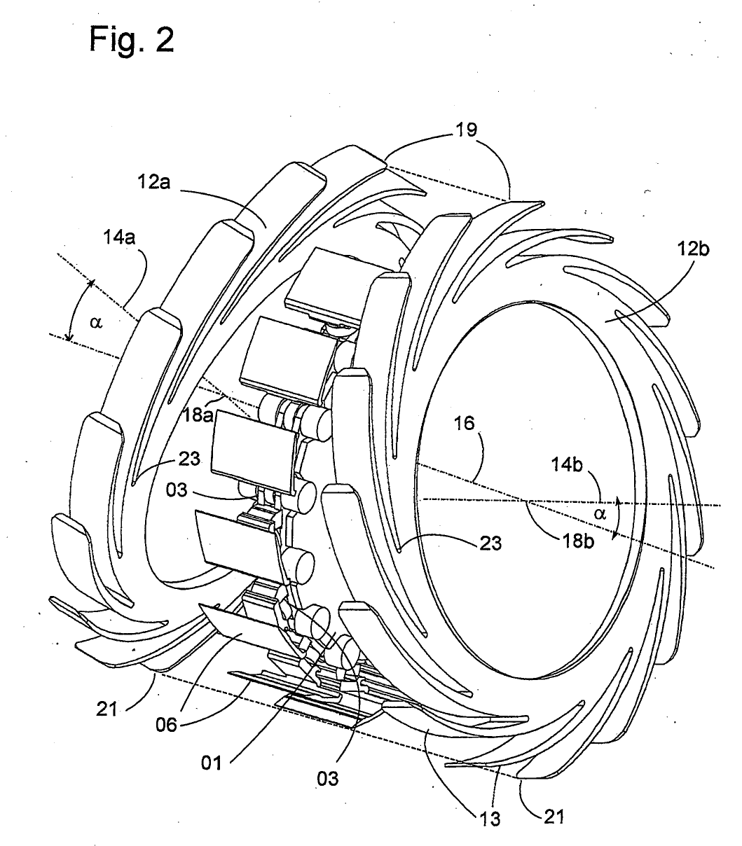

A deflection wheel 01 can be seen in the side elevation view of FIG. 1, which deflection wheel 01 is rotatable in a counterclockwise direction around an axis which is extending perpendicularly with respect to the plane of FIG. 1. Notches 02 are distributed evenly around the circumference of the deflection wheel 01, which notches 02 are engaged, over a portion of the circumference of the deflection wheel 01, by bolts of a link chain 03. This is also shown in FIG. 2. Every link 04 of the link chain 03 supports a gripper 06, with each gripper 06 being provided with a gripper mouth 07, which is bordered, on its side facing away from the link chain 04, by a clamping jaw 08, which clamping jaw 08 is rigidly connected with the chain link 04. On the side of the gripper 06, which is facing the chain link 04, the mouth 07 is bordered by a pivotable clamping jaw 09. The pivotable clamping jaw 09 is pivotable, in a spring-loaded manner, between a receiving position, in which the gripper mouth 07 is open for receiving a printed product 26, and a holding position, in which the pivotable clamping jaw 09 presses the printed product 26 against the fixed clamping jaw 08. These two positions are shown in FIG. 1.

The pivotable clamping jaw 09 is connected with a lever arm 11 which lever arm 11, in the course of the movement of each gripper 06, while it is supported on the circumference of the rotating deflection wheel 01, works together with a stationary cam for pivoting the clamping jaw 09 from the receiving position into the holding position.

A first paddle wheel disk 12a, which is arranged, in the perspective of the drawing of FIG. 1, behind the deflection wheel 01, has a plurality of printed product receiving paddles 13 of a number corresponding to a number of the notches 02 of the deflection wheel 01 on its periphery. Receiving pockets 41, which are defined by the paddles 13, and which are configured for receipt of the printed products 26, are respectively aligned with the gripper mouths 07 of grippers 06 located on the deflection wheel 01.

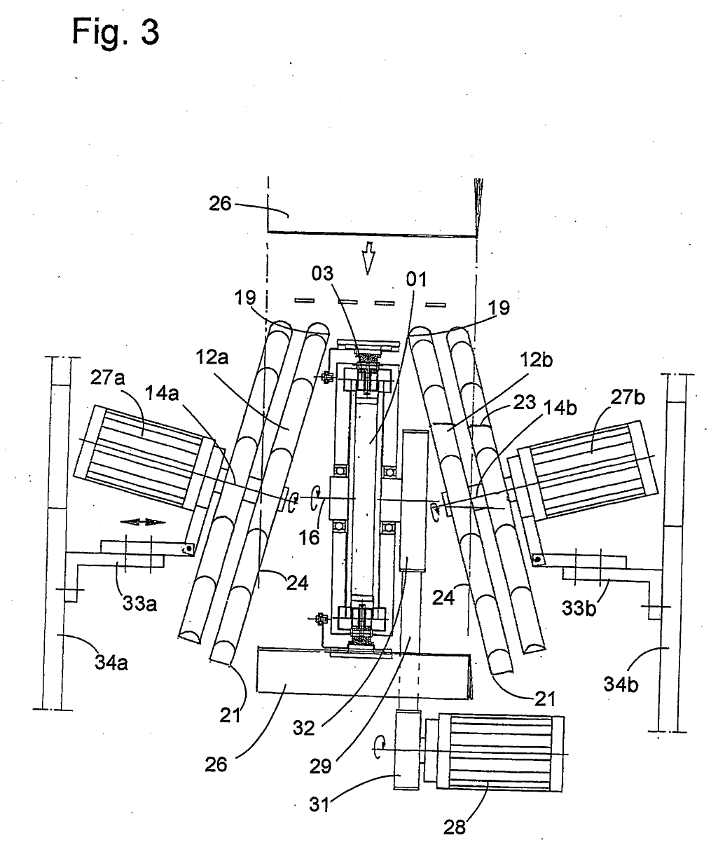

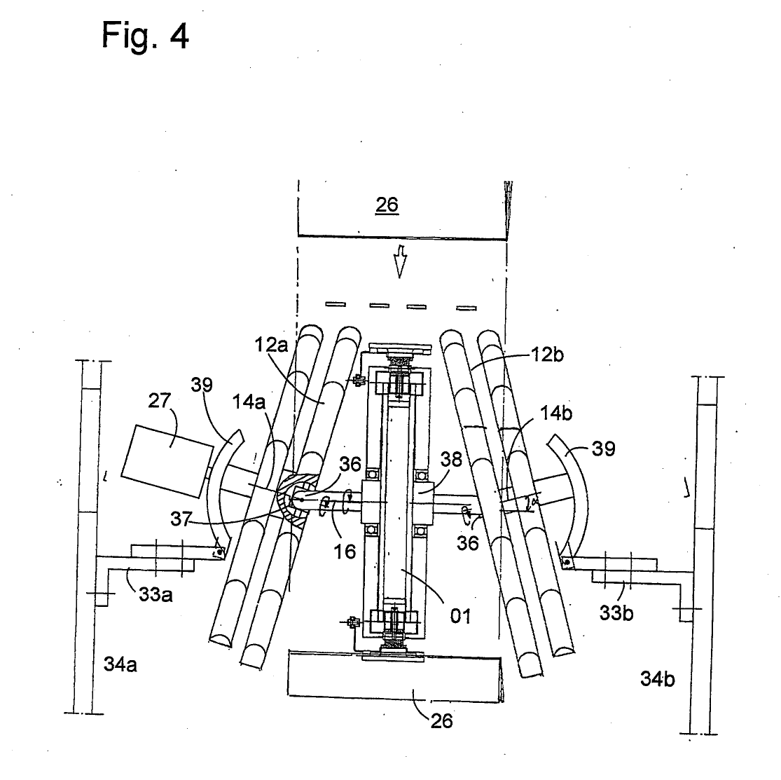

A second paddle wheel disk 12b, which is not visible in FIG. 1 but which can be seen by referring to FIGS. 2 and 3, is arranged in a mirror-symmetrical manner, in respect to the plane of FIG. 1, in relation to the paddle wheel 12a. As can be seen in FIGS. 2 and 3, the two paddle wheel disks 12a, 12b have rotational shafts 14a, 14b respectively, which rotational shafts 14a, 14b are inclined in relation to a rotational shaft 16 of the deflection wheel 01 at an angle α of 10° to 30° and which shafts 14a, 14b intersect the rotational shaft 16. The angle of intersection α, as seen in FIG. 2, can be fixed. However, in the embodiment of the present invention which is represented in FIGS. 3 and 4, links, which themselves can be fixed in place, and by the use of which, a holder of the respective shaft 14a or 14b is connected with a lateral frame plate 34a or 34b, permit a change of the angle α. For typical setting values of the angle α, an intersection point 18a or 18b of the axis of rotation of the deflection wheel rotational shaft 16 with the rotating shafts 14a, 14b of the paddle wheel disks 12a or 12b on the axes 14a, 14b lies at the level of the respective paddle wheel disk 12a or 12b, or in its interior.

In contrast to the paddle wheel disks 12a, 12b of FIG. 2, each of the paddle wheel disks 12a, 12b, which are represented in FIG. 3, is divided into two separate disk segments in the axial direction. However, this is the single difference between the embodiments in these figures, so that both can be described together here.

As a result of the inclination of the shafts, 14a, 14b there is a respective point 19 of the greatest or nearest approach, and a point 21 of the greatest distance or separation at the circumference of the paddle wheel disks 12a, 12b, which two points are located diametrically opposite each other. An insertion point 22 wherein printed products 26, which are received for example, from a folding apparatus, as seen in FIG. 3, fall into the pockets 41 of the paddle wheels 12a, 12b, is located closely behind the point of nearest approach 19, in the direction of rotation. Therefore, the spacing distance between the bottoms of the pockets 41 is short at the location of the insertion point 22. A lower edge of an inserted product 26 is supported at its respective ends by a bottom 23 of each pocket 41, and is supported in the center by the gripper mouth 07 of a gripper 06. In the course of the rotation of the device, the product 26 moves downward along the circumference of the deflection wheel 01. The clamping jaw 09, which was still open at the insertion point 22, is now closed and is effective for clamping the product 26. As the paddle wheel disks 12a, 12b continue to rotate, the distance between the product receiving pocket bottoms 23, on which bottoms 23 the product 26 rests, increases until finally, at a release point 24, the distance is greater than the width of the printed product 26. Starting at this release point 24, the paddles 13 no longer prevent a movement of the printed product 26 away from the deflection wheel 01, so that downstream of the release point 24, which is shortly ahead of, or before in the direction of rotation of deflection roller 01, the point 21 of the greatest separation or distance, the link chain 03 can be released from the deflection wheel 01 without there being a danger that the printed products 26 are buckled by the paddles 13.

As depicted in FIG. 3, the printed product receiving pocket bottoms 23 are inclined, in respect to the rotating shafts 14a, 14b of the paddle wheel disks 12a or 12b in which they are located, so that, in a typical position of the rotating shafts 14a, 14b, the pocket bottoms 23 are oriented approximately horizontally. The pocket bottoms 23 are moreover also slightly saddle-shaped, so that an inserted product 26 can also not hit a sharp edge at the pocket bottom 23, if the inclination of the paddle wheel disks 12a or 12b differs slightly from the typical position.

As can be seen most clearly in FIG. 3, the left and the right paddle wheel disks 12a, 12b and the deflection wheel 01 are each assigned their own electric drive motors 27a, 27b, 28, respectively. The electric motors 27a, 27b, 28 are regulated by the use of a suitable control circuit, which is not specifically shown, in such a way that they drive the paddle wheel disks 12a, 12b and the deflection wheel 01 at a uniform angular speed. The electric motors 27a, 27b act directly on the paddle wheel disk rotating shafts 14a, 14b. The electric motor 28 drives the deflection wheel 01 by the use of a drive belt 29 which is circulating between two pulleys 31, 32. In an arrangement which differs from the representation shown in FIG. 3, the electric motor 28 which drivers the deflection wheel 01 is not arranged below the deflection wheel 01, since, in that case, the drive belt 29 would collide with the conveyed products 26. Instead, in the perspective of FIG. 3, it lies horizontally behind the deflection wheel 01.

The paddle wheel disks 12a, 12b can be shifted parallel, in respect to the axis of rotation the deflection wheel 01, on support arms 33a, 33b, which, as seen in FIGS. 3 and 4, are mounted on right and left lateral frame plates 34a, 34b. The distance of the paddle wheel disks 12a, 12b from each other can be changed by shifting their position on the support arms 33a, 33b, and it is possible, by this distance variation capability, to adapt the transfer device of the present invention to accomplish the handling of printed products 26 of different widths.

FIG. 4 shows a modified embodiment of the transfer device of the present invention in a plan view which is analogous to that shown in FIG. 3. Only one electric paddle wheel disk drive motor 27 is provided in this embodiment, which sole drive motor 27 acts directly on the shaft 14a of the left paddle wheel disk 12a. The shaft 14a is coupled, by the provision of a universal joint 36, to the rotating shaft 16 of the deflection wheel 01. In this case, a cube or socket 37 of the universal joint 36, on which the two shafts 14a, 16 act and which defines the center point of the freedom of the pivoting movement of the shafts 14a, 16 in respect to each other, is located in the interior of the paddle wheel disk 12a.

The deflection wheel shaft 16 is kept stationary by the use of ball bearings 38 which are connected with the frame. The position of the shaft 14a is fixed at one end by the universal joint 36, its other end, which is its end facing the motor 27, can be both displaced and fixed in place by being positioned in a bow 39, which bow 39 is curved concentrically with respect to the universal joint 36, so that by shifting the shaft 14a arcuately along the bow 39, it is possible to set different angles of intersection a between the paddle wheel shafts 14a, and the deflection wheel rotational shaft 16.

The shaft 14b of the right paddle wheel 12b is held in an analogous manner between a second universal joint 36 and a second bow 39, which bow is concentric with respect to the second universal joint 36. The bows 39 are each maintained, so as to be displaceable in the direction of the shaft 16, on support arms 33a, 33b, which support arms 33a, 33b are mounted on lateral frame plates 34a, 34b. This displacement of the bows 39, in the direction of shaft 16 is provided in order to be able to adapt the distance between oppositely located paddle wheel disks 12a, 12b to printed products 26 of different width, the same as was done in the previous preferred embodiment, as shown in FIG. 3. For the same purpose, the shaft 16 is of a telescopic structure, which is not specifically shown in detail in the drawing figure, with a center section of shaft 16 supporting the deflection wheel 16, and with two head sections of shaft 16, which are connected, fixed against relative rotation, with the center section, and which are axially displaceable and each of which head sections acts on one of the two universal joints 36, respectively.

In an alternative to the embodiment represented in the drawing figure of FIG. 4, the single electric motor 27 could act, in a manner the same as the electric motor 28 in FIG. 3, via a belt or a comparable transmission mechanism, on the deflection wheel 01 and could drive the two paddle wheel disks 12a, 12b by this drive assembly.

While preferred embodiments of a bucket or paddle-wheel operated device for handing over or delivering printed products, in accordance with the present invention, have been set forth fully and completely hereinabove, it will be apparent to one of skill in the art that various changes in, for example the structure of the grippers and their method of actuation, the type of press used to print the folded products, and the like, could be made without departing from the true spirit and scope of the present invention which is accordingly to be limited only by the appended claims.

What is claimed is:

1-16. (canceled)

17. A device for transferring printed products comprising:
a paddle wheel assembly including at least first and second cooperating paddle wheels;
means supporting said first paddle wheel for rotation about a first paddle wheel axis of rotation;
means supporting said second paddle wheel for rotation about a second paddle wheel axis of rotation;
a deflection wheel arranged between said first and second cooperating paddle wheels and being rotatable about a deflection wheel axis of rotation; and
a printed product conveyor chain including a plurality of printed product grippers, said conveyor chain passing around said deflection wheel, said axis of rotation of said first and second paddle wheels each being inclined.

18. The device of claim 17 wherein said first and second paddle wheel axes of rotation are inclined with respect to said deflection wheel axis of rotation.

19. The device of claim 17 wherein said first and second paddle wheel axes of rotation are inclined with respect to each other.

20. The device of claim 17 further including a frame supporting said first and second paddle wheels and wherein said first and second paddle wheels are pivotable transversely to their axes of rotation.

21. The device of claim 17 wherein said axes of said first and second paddle wheels intersect said axis of said deflection wheel at an angle of between 10° and 30°.

22. The device of claim 17 further including an intersection point between said paddle wheel axes of rotation and said deflection wheel axis of rotation, said intersection point being located at each said paddle wheel.

23. The device of claim 17 wherein each said paddle wheel is displaceable along its axis of rotation.

24. The device of claim 17 wherein said deflection wheel is supported by a deflection wheel shaft which forms said deflection wheel axis of rotation.

25. The device of claim 17 further including a deflection wheel drive motor and separate first and second paddle wheel drive motors, each of said paddle wheel drive motors being located on a side of a respective one of said first and second paddle wheels remote from said deflection wheel.

26. The device of claim 17 further including a drive motor aligned to drive each of said first and second paddle wheels, and said deflection wheel at the same angular speed.

27. The device of claim 17 further including a single drive means for rotating both of said first and second paddle wheels.

28. The device of claim 25 wherein said drive motors are electronically coupled.

29. The device of claim 25 wherein said drive motors are mechanically coupled.

30. The device of claim 17 further including a plurality of product receiving paddles on each of said first and second paddle wheels, said first and second paddle wheels being spaced from each other in each paddle wheel assembly at a mean paddle wheel spacing distance, a distance between said first and second paddle wheels at an insertion point for inserting said printed products into said product receiving paddles being less than said mean paddle wheel spacing distance.

31. The device of claim 30 wherein a spacing distance between said first and second paddle wheels increases from said insertion point in a direction of rotation of said paddle wheel assembly.

32. The device of claim 30 wherein said conveyor chain is separated from said deflection wheel in an area of the circumferences of said first and second paddle wheels wherein said distance between said first and second paddle wheels is greater than said mean distance.

33. The device of claim 30 wherein said conveyor chain is separated from said deflection wheel in an area of the circumference of said first and second paddle wheels in which said distance is increasing in a running direction of said conveyor chain.
